(19) United States
(12) Patent Application Publication
(10) Pub. No.: US 2006/0026533 A1
(43) Pub. Date: Feb. 2, 2006

(54) Method for pointing and selection of regions in 3-D image displays

(76) Inventors: Joshua Napoli, Arlington, MA (US); Gregg E. Favalora, Arlington, MA (US)

Correspondence Address: CANTOR COLBURN, LLP, 55 GRIFFIN ROAD SOUTH, BLOOMFIELD, CT, 06002, US

(21) Appl. No.: 10/941,452

(22) Filed: Sep. 15, 2004

Related U.S. Application Data
(60) Provisional application No. 60/598,004, filed on Aug. 2, 2004.

(51) Int. Cl. G06F 17/00

(52) U.S. Cl. 715/850; 715/861

(57) ABSTRACT

A method for selecting a desired region of an image displayed by a three-dimensional display device includes using a pointing device in communication with the three-dimensional display device to direct a pointer to at least one of a desired position and orientation, the pointer displayed by the three-dimensional display device. The pointing device is used to engage a selection mechanism once the pointer is directed to at least one of a desired position and orientation.

### CROSS REFERENCE TO RELATED APPLICATIONS

This application claims the benefit of U.S. provisional application No. 60/598,004, filed Aug. 2, 2004, the contents of which are incorporated by reference herein in their entirety.

### BACKGROUND

The present invention relates generally to three-dimensional (3-D) image displays and, more particularly, to methods for pointing at and selecting regions of a 3-D image as presented by a 3-D display, including scenarios for collaboration.

There are many types of 3-D displays presently in existence, including those that are commercially available and those that have only been experimentally developed. Examples of such displays include stereoscopic displays, multiplanar volumetric displays (e.g., U.S. Pat. No. 6,554,430, entitled “Volumetric three-dimensional display system”), holographic video systems (e.g., U.S. Pat. No. 5,172,251, entitled “Three-dimensional display system”), and multi-view 3-D displays. Specific applications for 3-D displays include the depiction of medical images, such as for example: a transparent CT image of a patient's anatomy which may depict vasculature and tumors; geophysical data for the petroleum industry, such as seismic data overlaid with drill paths; and 3-D luggage scan data, such as a CT scan of luggage in which each 3-D pixel (“voxel”) is color coded as a function of effective atomic number.

However, there are also certain drawbacks associated with respect to existing 3-D displays, as well as the software designed for such 3-D displays. For example, it is difficult for a user to point at regions of the 3-D image (e.g., for the purpose of indicating to co-workers, or to inform the associated application software). Furthermore, it is also difficult for a user to select one or more regions of the 3-D image (again, for the purpose of indicating to co-workers, or to inform the associated application software of regions for various operations to occur, such as highlighting or “cut and paste” operations in 3-D).

Accordingly, it would desirable to be able to implement effective methods for pointing at and selecting regions of interest (objects) displayed in a 3-D display system.

### SUMMARY

The foregoing discussed drawbacks and deficiencies of the prior art are overcome or alleviated by a method for pointing at a desired region of an image displayed by a three-dimensional display device. In an exemplary embodiment, the method includes using a pointing device in communication with the three-dimensional display device to change the appearance of a pointer displayed within the three-dimensional display device so as to gesture to the desired region.

In another embodiment, a method for selecting a desired region of an image displayed by a three-dimensional display device includes using a pointing device in communication with the three-dimensional display device to direct a pointer to at least one of a desired position and orientation, the pointer displayed by the three-dimensional display device. The pointing device is used to engage a selection mechanism once the pointer is directed to at least one of a desired position and orientation.

In still another embodiment, a method for highlighting a user-selected region of an image displayed by a three-dimensional display device includes causing the user-selected region to change in appearance with respect to unselected regions of the image displayed in the three-dimensional display device.

### BRIEF DESCRIPTION OF THE DRAWINGS

Referring to the exemplary drawings wherein like elements are numbered alike in the several Figures:

FIG. 1 is an exemplary scene depicted in a three-dimensional (3-D) display;

FIG. 2(a) illustrates the scene of FIG. 1 in a multiplanar volumetric display;

FIG. 2(b) illustrates the scene of FIG. 1 in a stereoscopic 3-D display;

FIG. 3 illustrates a 3-D pointing device in communication with a 3-D display 118, in which position of a 3-D pointer of the display is controlled by the pointing device, in accordance with an embodiment of the invention;

FIG. 4 is an alternative embodiment of the pointing method of FIG. 3, in which the pointer is directed in terms of orientation, and in terms of both position and orientation;

FIG. 5 illustrates a method of depicting region selection in a 3-D display by shading the selected region, in accordance with another embodiment of the invention;

FIG. 6 is an alternative embodiment of FIG. 5, in which the selected scene element is ghosted;

FIG. 7 is an alternative embodiment of FIG. 5, in which the selected scene element is surrounded by a marquee;

FIG. 8 illustrates an exemplary selection sequence in which the position of a pointer is moved in or near a scene element, followed by issuing a selection command, such as a button press, in accordance with further embodiment of the invention;

FIG. 9 is an alternative embodiment of the selection sequence of FIG. 8, wherein the pointer is caused to change in orientation prior to the selection of the selected object;

FIG. 10 illustrates an exemplary sequential selection sequence in which multiple scene elements may be selected by completing a path between the elements of interest, in accordance with a further embodiment of the invention;

FIG. 11 illustrates an alternative embodiment of the sequential selection sequence of FIG. 10 in which a two-dimensional area is drawn around the region of interest to be selected;

FIG. 12 illustrates an alternative embodiment of the sequential selection sequence of FIGS. 10 and 11 in which a three-dimensional area is drawn around the region of interest to be selected; and

FIG. 13 illustrates still another embodiment of a selection sequence in which one or more elements are selected by placing a surface near or through the regions of interest.

### DETAILED DESCRIPTION

Disclosed herein is a method for pointing at a region of an image in a three-dimensional display using position (e.g., (x,y,z) coordinates), using both position and orientation (e.g., (x,y,z) coordinates with a given angular bearing), and using orientation (a given angular bearing at a region). Additionally disclosed herein is a method and system for selecting a region of an image using a n-dimensional tool ranging from a 0-D selection tool (e.g., point-and-click), to a 1-D selection tool (e.g., drawing a path such as a line segment, or rubber-band, or squiggly line through one or more scene elements), to a 2-D selection tool (e.g., drawing a circle or other closed figure around or within one or more scene elements, placing a 2-D surface beneath, next to, or inside of one or more scene elements), to a 3-D selection tool (e.g., drawing a 3-D volume which selects anything contained therein), to a 4-D selection tool (e.g., a time-domain recording feature implemented during playback of an animation, wherein pressing a selection button records the time of selection).

In addition, disclosed herein is a method for depicting region selection in which (in one embodiment), the depiction of the selected region is carried out, for example, by changing the color or shading of the region, changing brightness of the region, changing “cross hatching” or ghosting, causing the region to blink on and off (for a short period or a long period), and placing a marquee around the region(s) that are selected. Alternatively, the depiction of everything except the selected region may be changed such as by dimming everything not selected.

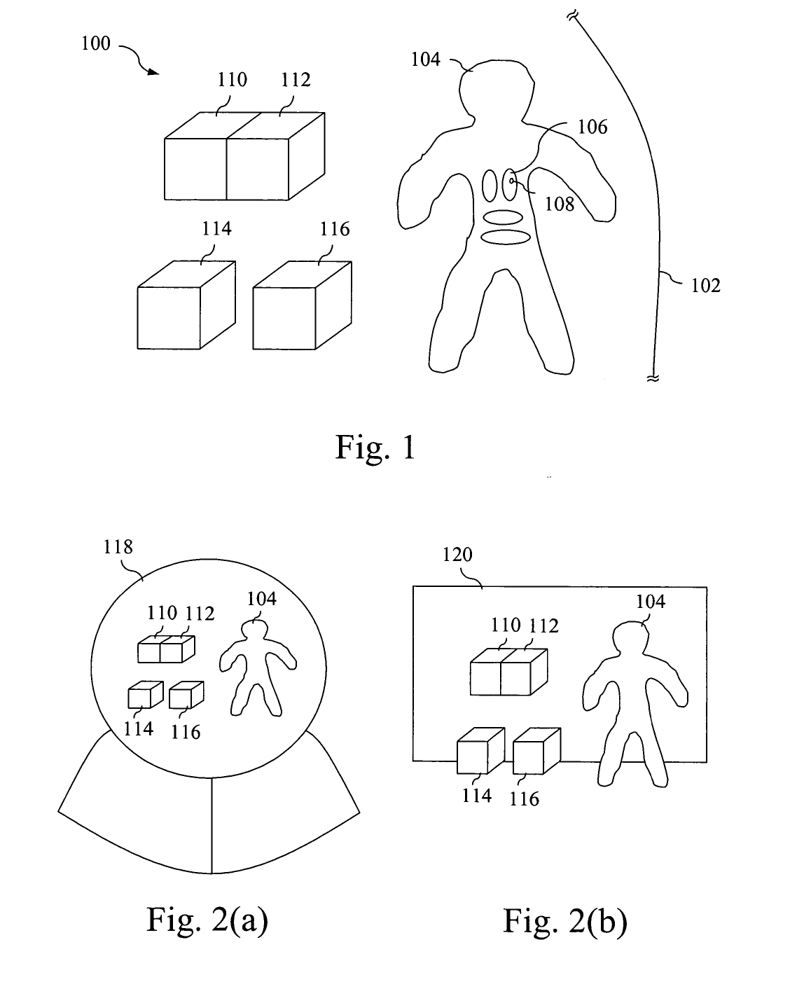

Referring initially to FIG. 1, there is shown a scene 100 depicted in a three-dimensional (3-D) display 102. The scene 100 includes a medical image illustrating an individual's body 104, an organ 106 within the body 104, and a tumor 108 inside the organ 106. Scene 100 further includes two connected (abutting) scene elements 110, 112, as well as two disconnected scene elements 114, 116. FIGS. 2(a) and 2(b) illustrate the depiction of the scene 100 in two types of 3-D displays. In particular, FIG. 2(a) is a multiplanar volumetric display 118, such as the Perspecta® volumetric display available from Actuality Systems, Inc., while FIG. 2(b) illustrates a stereoscopic 3-D display 120.

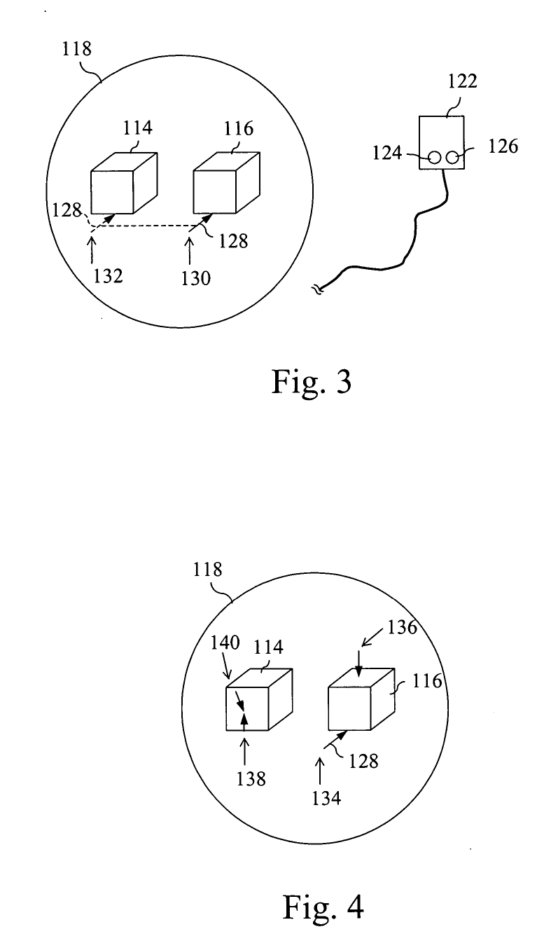

In practical applications, it is often the case for one or more individuals to use a 3-D display at the same time, such as a case where it becomes desirable to be able to point at a region of the displayed scene for communication or data-selection purposes. FIG. 3 illustrates a 3-D pointing device 122 (e.g., a mouse), which may be a positional input device or a positional and directional input device, optionally having one or more buttons 124, 126 associated therewith. The 3-D mouse 122 is in communication with the 3-D display 118, and may direct a 3-D pointer 128 with respect to its position within the display 118. As shown in the example of FIG. 3, the 3-D pointer 128 is initially in a first location 130 such that it points at a first scene element 116. If the position and/or orientation of the 3-D mouse 122 are changed, the pointer 128 may be correspondingly moved from the first location 130 to a second location 132 so as to point at a second scene element 114. In this example, the location of the pointer 128 changes but the orientation thereof stays the same.

However, as illustrated in FIG. 4, the pointer 128 may also be directed in terms of orientation. For example, with respect to the first scene element 116, the pointer 128 may change in both location and orientation as shown at location 134 (pointing to the bottom of element 116) and location 136 (pointing to the top surface of element 116). Alternatively, the pointer 128 may be directed to change in terms of orientation but not position. For example, with regard to second scene element 114, orientation 138 is “up,” while orientation 140 is “down.”

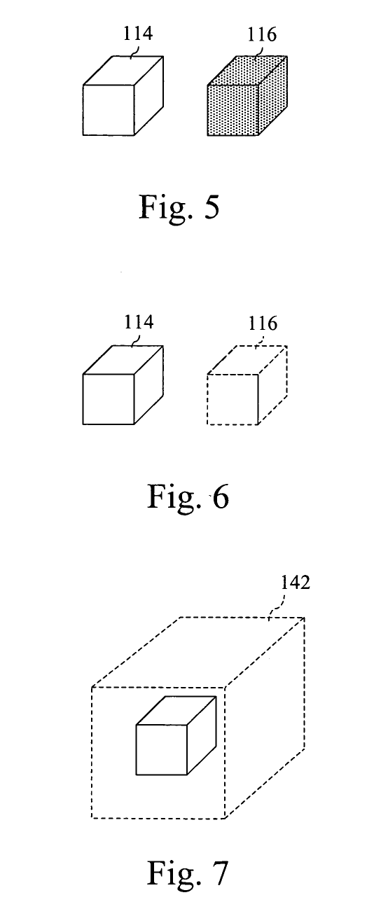

In another embodiment, the pointer may also be used to select regions of a 3-D scene. The results of such a selection may be used, for example, as an aid in communications, or to inform an application that it is to perform a desired operation on a selected region of the scene. Once a region has been selected, there are several ways in which the selection may be depicted in a 3-D display. For example, as shown in FIG. 5, the selected area may change in terms of color, brightness, or frequency and duty cycle of flashing. In particular, first scene element 116 is selected, as represented by the shading thereof, while second scene element 114 is unselected. Alternatively, the selected (or unselected) region may appear as crosshatched or “ghosted.” In the example of FIG. 6, the selected scene element 116 is ghosted. In still another embodiment, the selected region may have a marquee 142 or other shaded or stippled surface appear around or within it, as shown in FIG. 7. It will further be appreciated that, alternatively, the depiction of all unselected regions of the display may be change (such as described above) in lieu of the selected region.

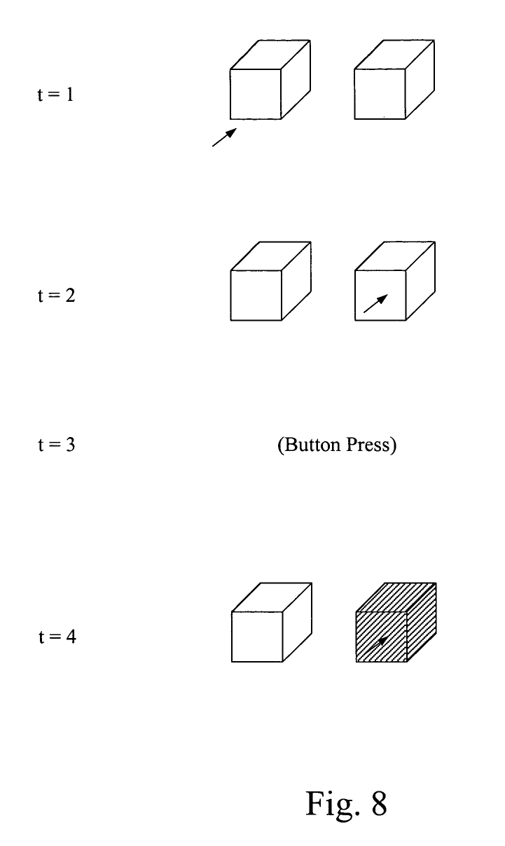

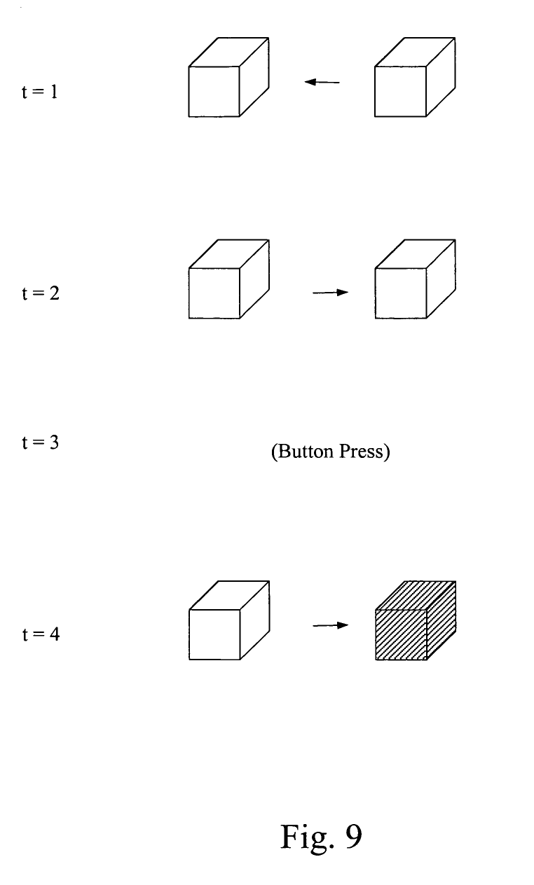

Regardless of how a selected region in a 3-D display is depicted, there are also several ways to direct the 3-D display or software application to select a region. In the embodiments described below, multiple regions may be connected by a sequence of selections or actions, which are in turn “linked” by depressing another key, such as CONTROL or SHIFT, for example. More specifically, FIG. 8 illustrates one possible way of selecting a region of an image by placing the pointer in or near a scene element and then issuing a selection command, such as a button press. Here, at time t=1, the pointer is moved from a first location to a second location at time t=2. At time t=3, the user presses a mouse or other button to activate selection of the region at the second location, and at time t=4 the region of the scene is shown as selected. The selected region is illustrated in FIG. 8 a change in color of the selected region. An alternative selection sequence shown in FIG. 9 is similar to that of FIG. 8, except that the pointer is caused to change in orientation (rather than in position) prior to the selection of the selected object.

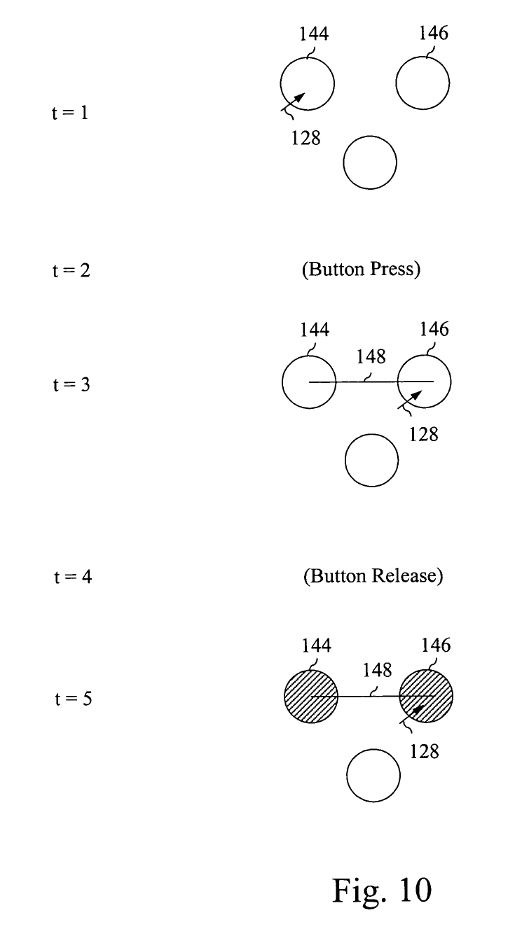

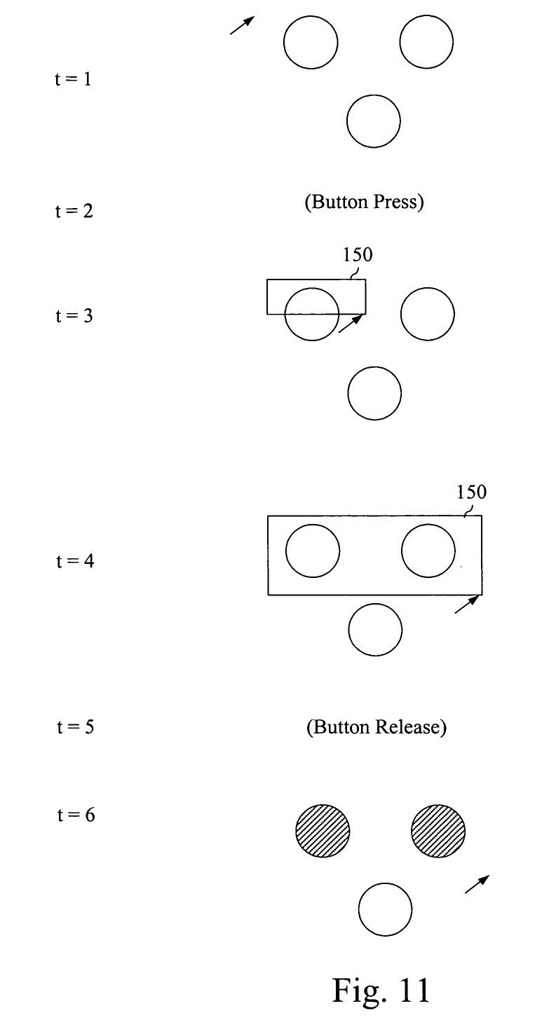

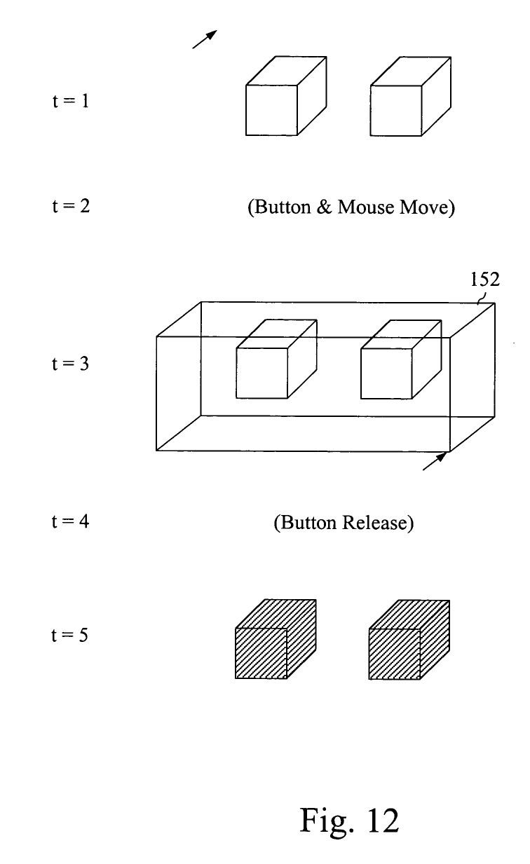

FIG. 10 illustrates an exemplary sequential selection sequence in which multiple scene elements may be selected by completing a path (e.g., by drawing a “rubber band,” line segment or other connecting structure) between the elements of interest. At time t=1, the pointer 128 is shown at a first location corresponding to a first scene element 144 to be selected. Once a button is engaged (or other similar user-initiated operation) at time t=2, a path 148 is then drawn from the first location to a second location corresponding to a second scene element 146 to be selected, as shown at time t=3. After the button is released (or other appropriate user-initiated operation) at time t=4, both of the selected scene elements 144, 146, by virtue of path 148, are highlighted (i.e., “selected”) at time t=5. Alternatively, a two-dimensional area 150 (e.g., a rectangular or circular area) may be drawn around the region of interest to be selected, as shown in the sequence of FIG. 11. In FIG. 12, a three-dimensional volume or volume surface 152 is drawn around one or more scene elements to facilitate the selection thereof.

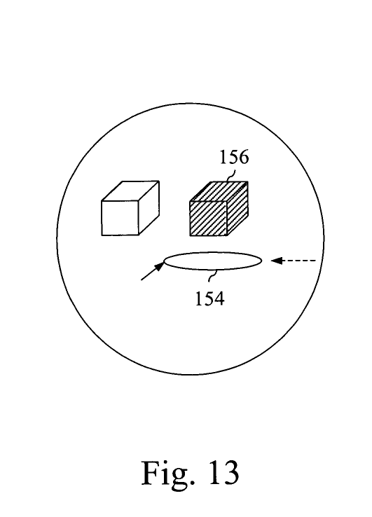

Finally, FIG. 13 illustrates still another embodiment of a selection sequence in which one or more elements may be selected by placing a surface near or through the regions of interest. In the example illustrated, a circular disc 154 is positioned beneath a cube-shaped object 156, which enables the object 156 to be selected and highlighted. Alternatively, the disc 154 may also be positioned so as to intersect the object 156.

In addition to the above described embodiments, an alternative way to select elements in a scene, or frames of a scene, is to record the time of one or more button presses. For example, if a user clicks the mouse button during the playback sequence of a beating heart, the frames of the heart displayed at the time of the button press or presses will be selected. Furthermore, regions of a scene may also be selected that are otherwise inconvenient to accomplish through any of the above described embodiments. One specific example may be the case of scene elements that are spatially far apart or disconnected. In such case, a user can press a “linking button,” such as CONTROL, select one region, select a second region, and thereafter release CONTROL. This will result in two regions being selected.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Existing systems having reprogrammable storage (e.g., flash memory) can be updated to implement the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for pointing at a desired region of an image displayed by a three-dimensional display device, the method comprising:
using a pointing device in communication with the three-dimensional display device to change the appearance of a pointer displayed by the three-dimensional display device so as to gesture to the desired region.

2. The method of claim 1, wherein said changing the appearance of said pointer further comprises changing the position of said pointer with respect to a three-dimensional coordinate system.

3. The method of claim 1, wherein said changing the appearance of said pointer further comprises changing the orientation of said pointer with respect to an angular bearing thereof.

4. The method of claim 1, wherein said changing the appearance of said pointer further comprises changing the position of said pointer with respect to a three-dimensional coordinate system, and changing the orientation of said pointer with respect to an angular bearing thereof.

5. A method for selecting a desired region of an image displayed by a three-dimensional display device, the method comprising:
using a pointing device in communication with the three-dimensional display device to direct a pointer to at least one of a desired position and orientation, said pointer displayed by the three-dimensional display device; and
using said pointing device to engage a selection mechanism once said pointer is directed to said at least one of a desired position and orientation.

6. The method of claim 5, wherein said selection mechanism further comprises a zero dimensional tool such that selection of the desired region is defined by said at least one of a desired position and orientation of said pointer once said selection mechanism is engaged.

7. The method of claim 6, wherein said selection mechanism is engaged by a point-and-click operation of said pointing device.

8. The method of claim 5, wherein said selection mechanism further comprises a one-dimensional tool such that selection of the desired region is defined by creating a one-dimensional path beginning at a first location of said pointer, and ending at a second location of said pointer.

9. The method of claim 8, wherein said one-dimensional path is created through one or more scene elements of said desired region.

10. The method of claim 8, wherein said one-dimensional path is created as a closed path around one or more scene elements of said desired region.

11. The method of claim 5, wherein said selection mechanism further comprises a two-dimensional tool such that selection of the desired region is defined by creating a two-dimensional construct beginning at a first location of said pointer, and ending at a second location of said pointer.

12. The method of claim 11, wherein said two-dimensional construct is created through one or more scene elements of said desired region.

13. The method of claim 11, wherein said two-dimensional construct is created around one or more scene elements of said desired region.

14. The method of claim 11, wherein said two-dimensional construct is created in proximity to or more scene elements of said desired region.

15. The method of claim 5, wherein said selection mechanism further comprises a three-dimensional tool such that selection of the desired region is defined by creating a three-dimensional construct beginning at a first location of said pointer, and ending at a second location of said pointer.

16. The method of claim 15, wherein said three-dimensional construct is created within one or more scene elements of said desired region.

17. The method of claim 15, wherein said three-dimensional construct is created around one or more scene elements of said desired region.

18. The method of claim 5, wherein said selection mechanism further comprises a four-dimensional tool such that selection of the desired region is defined by recording instances in time during a play sequence of a scene in said three-dimensional display.

19. The method of claim 5, wherein said desired region further comprises a first scene element at a first location and a second scene element at a second location, and wherein a linking function of said pointing device is used to select said second scene element without unselecting said first scene element.

20. A method for highlighting a user-selected region of an image displayed by a three-dimensional display device, the method comprising:
causing the user-selected region to change in appearance with respect to unselected regions of the image displayed in the three-dimensional display device.

21. The method of claim 20, wherein said user-selected region is caused to change in appearance by changing the color thereof.

22. The method of claim 20, wherein said user-selected region is caused to change in appearance by changing the brightness thereof.

23. The method of claim 20, wherein said user-selected region is caused to change in appearance by changing at least one of a frequency and a duty cycle of flashing thereof.

24. The method of claim 20, wherein said user-selected region is caused to change in appearance by cross-hatching thereof.

25. The method of claim 20, wherein said user-selected region is caused to change in appearance by creating a surface around said user-selected region.

26. The method of claim 20, wherein said user-selected region is caused to change in appearance by creating a surface within said user-selected region.
